(19) United States
(12) Patent Application Publication
(10) Pub. No.: US 2007/0086435 A1
(43) Pub. Date: Apr. 19, 2007

(54) Sharing devices on peer-to-peer networks

(75) Inventor: Christopher G. Kaler, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/253,837

(22) Filed: Oct. 19, 2005

(51) Int. Cl. H04L 12/66

(52) U.S. Cl. 370/352; 370/401

(57) ABSTRACT

Providing access to devices based on peer membership. A method is described including an act of providing access to a device, such as a hardware peripheral or a software service, to networked agents, such as host computers, operating systems, frameworks, and application code. The method includes an act of forming a peer-to-peer network of one or more members from among the networked agents. The one or more members form a peer group. The peer group does not require a central authority defining peer group membership. Access to a device is provided to the one or more members forming the peer group based on their being included in the peer group.

### BACKGROUND

Modem computers often include functionality for connecting to other computers. For example, a modem home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Computers can be interconnected in various topologies. For example, one topology is a client-server topology. In a client server topology, a central authority maintains control over the network organization. The central authority can provide routing functionality by providing network addresses to clients on the network. When the central authority becomes disabled or non-functional, network communications can be hampered or completely disabled.

In a client-server topology, network devices and software services may be available to clients through access provided by a server. For example, a print server may allow access to clients on the network to a printer.

Another type of topology is a peer-to-peer network. In a peer-to-peer network, no central authority is necessary to define the network organization. Rather peer-to-peer networks are formed as a self selected group assembled for a purpose. Rather than requiring a central authority to identify network members, the peers in a peer-to-peer network can identify network members by providing and examining tokens, sharing a common encryption or key, and the like.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described in further detail herein includes a method of providing access to a device, such as a hardware peripheral or a software service, to networked agents, such as host computers, operating systems, frameworks, and application code. The method includes an act of forming a peer-to-peer network of one or more members from among the networked agents. The one or more members form a peer group. The peer group does not require a central authority defining peer group membership. Access to a device is provided to the one or more members forming the peer group based on their being included in the peer group.

In another embodiment, a method of providing access to a device to networked agents is described. The method includes receiving a request for device access from one of the networked agents. The networked agent is a member of a peer group. The peer group does not require a central authority defining peer group membership. The method further includes an act of verifying that the networked agent is a member of the peer group. Access is granted to the networked agent based on membership in the peer group.

Yet another embodiment described herein includes a computer system configured to provide access to a device to agents. Access is provided to devices connected in a peer-to-peer fashion such that the agents are organized into peer groups where the peer group does not require a central authority defining peer group membership. The computer system includes a processor configured to run program modules. A storage medium is included in the computer system as is configured to store data and program modules. The storage medium includes a program module configured to verify membership in the peer group for one or more agents and to provide access to the device to agents based on peer group membership.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teaching herein. The features and advantages of the teaching herein may be realized and obtained by means of the instruments and combinations particulary pointed out in the appended claims. These and other features will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description will be rendered by reference to specific embodiments thereof which are illustrated in the appened drawings. Understanding that these drawings depict only typical embodiments and are not therefore to be considered to be limiting in scope, embodiments will be described and explained with additional specificity and detail through the use of the accompanying drawings in which:

FIG. 1 illustrates a network topology where various embodiments may be implemented;

FIG. 2 illustrates a method of providing access to devices to members of a peer group;

FIG. 3 illustrates a method of granting access to devices to members of a peer group; and

FIG. 4 illustrates an exemplary computer system where embodiments may be implemented.

### DETAILED DESCRIPTION

One example embodiment includes a peer-to-peer network where devices are shared on the peer-to-peer network. In this example, one or more networked agents, such as host computers, operating systems, frameworks, application code and the like are formed into a peer-to-peer network with membership in a peer group. Members of the peer group are granted access to network devices, such as hardware peripherals and software services, by virtue of their membership in the peer group. Thus, peer group membership can be used to determine access rather than access being granted based solely on device permissions. For example, rather than requiring appropriate credentials to access a device, a member can simply show that they are a member of a peer group to gain access to a device. Alternatively, all members are provided access to a device based on peer group membership. Notably, one method of showing membership in a peer group is by presenting appropriate credentials. However, these credentials show membership in the peer group and are not used specifically to grant access to the device. Rather, members of the peer group are granted access to the device.

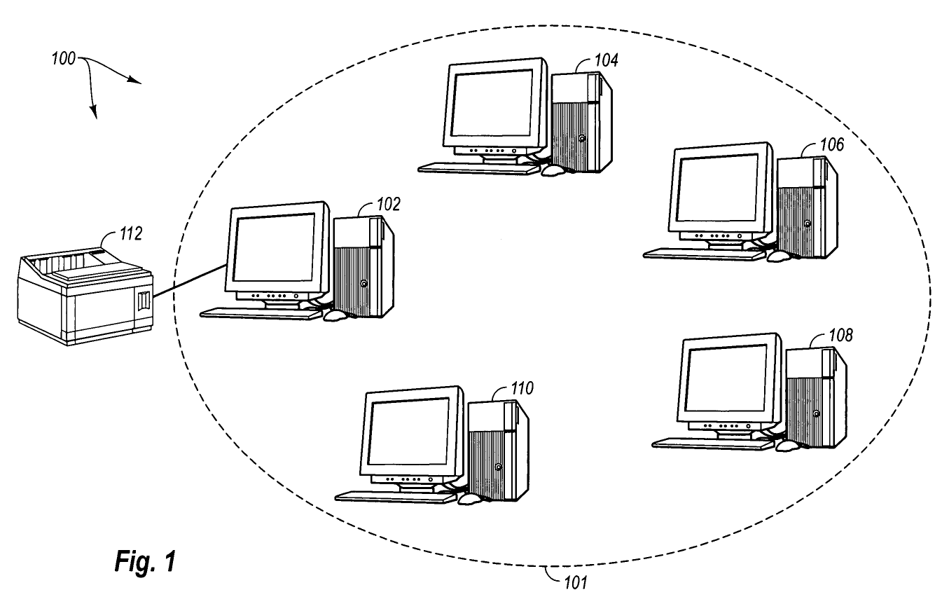

Referring now to FIG. 1, a topology 100 is illustrated where a peer group 101 includes computer systems 102-110 interconnected in a peer-to-peer fashion. The computer systems 102-110 may be interconnected through a variety of means. For example, the computer systems 102-110 may be interconnected by various network connections such as those complying with the IEEE 802.3 standard. In alternative embodiments, the computer systems 102-110 may be interconnected via wireless connections such as those complying with the IEEE 802.11 standard, or the Bluetooth standard. In yet another alternative embodiment, the computer systems 102-110 may be interconnected through various dial-up networking connections, cable modem, connections, dsl connections, satellite connections, or other network or direct connections.

Notably, while the computer systems 102-110 are shown as individual personal computing systems, it should be noted that the computer systems 102-110 can be different computer system components connected in peer-to-peer fashion. For example, a peer group 101 may include a collection including wired or wireless intelligent keyboards, mice, and other peripherals. Such other peripherals may include cell phones, pdas or other handheld devices. In addition, other peripherals, though not specifically enumerated here, may be a peer in a peer-to-peer network. One notable example of a peer-to-peer network occurs when various individual components are interconnected at a single host computer through Bluetooth connections. Further, it should be noted that while individual personal computers are shown as members of the peer group 101, members may also include software such as operating systems, frameworks, application code and the like.

Referring once again to FIG. 1, the topology 100 shows a device 112 that in this example is a printer connected to computer system 102. Thus, in this example, the device 112 is one device that it shared to the computers systems 102-110 by virtue of their inclusion in the peer group. While in this example, the device 112 is a physical computer peripheral device, is should be noted that other devices can include software services. Thus, when a device is recited herein, embodiments are not limited to hardware devices.

The computer systems 102-110 each have access to the device 112 by virtue of their being members of the peer group 101. Several methods of providing access to peer group members may be implemented. For example, in one embodiment, an access control entry (ACE) may be added to an access control list (ACL) that controls access to the device 112. The access control entry, in this embodiment, identifies the peer group 101 as having access to the device 112. This may be used to leverage existing access control infrastructure. In this embodiment, a reverse look-up can be used on the ACE to discover members of the peer group 101 for providing access to the members of the peer group 101.

In one embodiment, access to devices can be granted simply based on being a member of the peer group 101. For example, one method of showing membership in a peer group is by presenting appropriate credentials showing membership in the peer group.

In an alternative embodiment, and with a specific reference to the topology 100 shown in FIG. 1, a service may be available within the peer group 101 only to members of the peer group 101. The service allows members of the peer group 101 to obtain a security token or key authorizing usage of the device 112. This allows members of the peer group 101 to directly access the device 112 or other devices by virtue of their membership in the peer group 101.

In yet another alternative embodiment a service may be provided within the peer group 101 which is available to members of the peer group 101. The service automatically registers the identities of members of the peer group 101 that contact the service in an ACL. In one embodiment, registration in the ACL is performed such that the registration is valid or exists for a given period of time. The registration, in this example, can be renewed as long as a computer system maintains membership in the peer group 101.

Services described herein, may be, for example Web Services. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

In another alternative embodiment a device 112 may be added to the peer group 101 as a member of the peer group. In this example, the device interrogates members of the peer group 101 and automatically adjust an ACL at the device 112 to allow members of the group to access and utilize the device 112. Thus, in this example the delineation of the peer group 101 shown in FIG. 1 would be expanded to include the device 112.

Notably, each of the alternative embodiments described above may be implemented at a host for the device or at the device itself. For example, device 112 may maintain an ACL at the device 112. The device 112 may include functionality to perform a reverse look-up on peer group entries in the ACL. In other embodiments, the device 112 may host a service that is only accessible by members of the peer group 101. The service may allow access to the device 112 or may add members who access the service to an ACL.

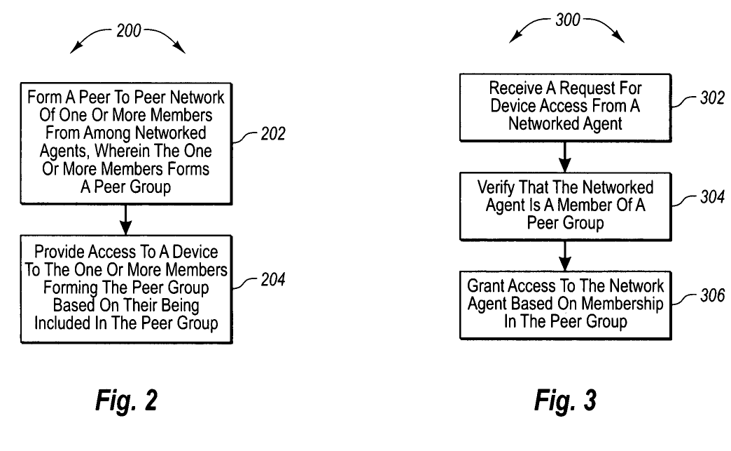

Referring now to FIG. 2, a method 200 of providing access to a device is illustrated. As described above, a device may be a hardware peripheral or software service. The method 200 may be practiced, for example, in a computer network including networked agents. As described above, networked agents may include any one of a number of different items including host computers, operating systems, frameworks, application code, etc.

The method 200 includes an act of forming a peer-to-peer network of one or more members from among the agents, wherein the one or more members forms a peer group (act 202). A peer group, in this example is one in which no central authority is needed to define the peer group membership. For example, a peer group may include members of a trust group where the members of the peer group communicate using messages that are encrypted using a key used by members of the peer group to accomplish peer-to-peer communication. Alternatively, peers in a peer group may be identified by the ability to present credentials, such as a token, known to members of the peer group. Members of a peer group may be identified by virtue of the fact that they are running a specific software application. Various other methods of peer group identification may also be used. Often peer groups are formed at a level above the network level. In other words, membership on a network, without more, may not be sufficient to be a member of a peer group.

The method 200 further includes an act of providing access to the one or more members forming the peer group based on their being included in the peer group (act 204). Providing access to the members to the device (act 204) can be accomplished in a number of different fashions as described above in conjunction with the description of FIG. 1. For example, in one embodiment, a host coupled to the device could be a member of the peer group. The host could include functionality to provide access to the one or more members based on their being included in the peer group. Because the host is a member of the peer group, it would include functionality to identify other members of the peer group. This functionality would also allow the host to grant access to the device based on peer group membership.

In an alternative embodiment providing access to a device (act 204) may comprise adding the members to an ACL. This may be accomplished for example by having a service available on the peer-to-peer network that members of the peer-to-peer network can register with. When a member registers with the service, the service automatically adds the member to an ACL that controls access to the device.

In an alternative embodiment, providing access to a device to members of a peer group (act 204) may be accomplished by the entire peer group being added to an ACL controlling access to the device. In this example, a reverse look-up can be performed against a peer group identifier in the ACL to determine if an individual agent is a member of a peer group. By confirming membership of the agent in the peer group, access to the agent may be granted to the device.

In another alternative embodiment, providing access to a device to members of a peer group (act 204) may be accomplished by including the device as a member of the peer group. In this embodiment, by the device having membership in the peer group, the device also has the ability to identify other members of the peer group. Once agents have been identified as members of the peer group, they can be granted access to the device.

Referring now to FIG. 3, another exemplary embodiment is illustrated. FIG. 3 shows a method 300 of providing access to a device. The device may be included on a network including networked agents. By being included on the network, the device does not need to necessarily be connected by a network connection, but rather may be connected to one of the agents acting as a host device.

The method 300 includes an act of receiving a request for device access from a networked agent (act 302). The networked agent is a member of a peer group. The peer group does not require a central authority defining peer group membership. Receiving a request (act 302) may be performed at various locations, including at a host device which is a member of the peer group, at the device, at some other service on the peer group, etc.

The method 300 further includes an act of verifying that the networked agent is a member of the peer group (act 304). Verifying that the networked agent is a member of the peer group may be accomplished in various ways, including by performing a reverse look-up of an ACE for the peer group. For example, the ACL may include an ACE where the ACE is the peer group. A service may perform a reverse look-up to see if the agent is a member of the peer group identified in the ACE. In an alternative embodiment, verifying that the networked agent is a member of the peer group (act 304) may be performed by verifying that the networked agent and the device are in the same peer group. In other words, access to a peer group may be granted by including the device in the peer group and instructing the device to provide access to any peers in the peer group.

Method 300 further includes an act of granting access to the network agent based on membership in the peer group. As described previously herein, granting access allows agents to utilize the devices resources.

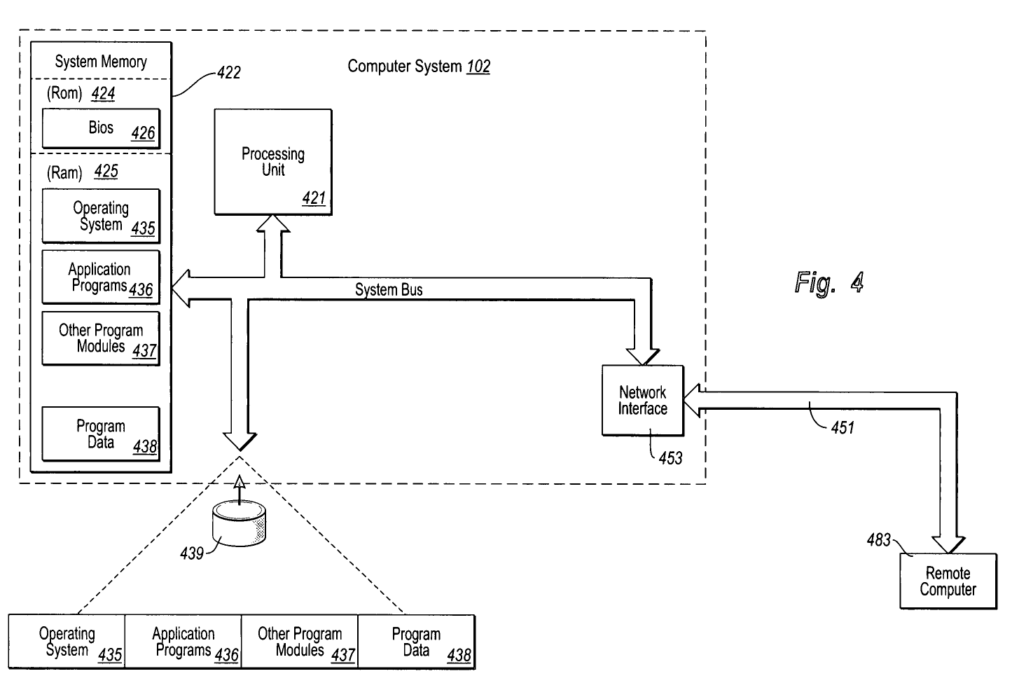

Referring now to FIG. 4, an exemplary computer system 102 is illustrated. The computer system 102 may include functionality for providing access to a device 112 (FIG. 1) to agents, such as the remote computer system 483 or other agents as set forth above, in a peer-to-peer fashion. The agents may be organized into peer groups, where, as described above, the peer groups do not require a central authority defining peer group membership. The computer system 102 may include a processor 421. The processor 421 is configured to operate on computer executable instructions. For example, the processor may be configured to run instructions stored in the BIOS 426 in ROM 424, as part of an operating system 435 and various program modules including application programs 436 and other program modules 437. These program modules may be stored on a hard disk 439 or other media where they may be loaded into system memory 422 for execution by the processor.

The computer system also includes, as alluded to above, storage media configured to store data and program modules. For example, application programs 436 can be stored on the hard drive 439 where they can be loaded into the RAM 425 of the system memory 422. Similarly, program data 438 may be stored on the hard drive 439 and stored in the RAM 425 of the system memory 422.

A storage medium may include a program module 437 configured to verify membership in a peer group for one or more agents. When membership has been verified, the program module 437 may allow the agent(s) to access a device 112 based on the agent(s) membership in the peer group.

In one embodiment, the program module 437 may include a service that is configured to add members in the peer group to an ACL. The ACL could then be referenced when requests for access to the device 112 are issued from the agents.

In another embodiment, the computer system 102 or the program module 437 may be included as a member of the peer group. This allows the computer system 102 or program module 437 to verify membership of agents in the peer group by verifying that the agents are in the same peer group as the computer system 102 or program module 437.

In another embodiment, the device 112 may be included in the computer system 102. As with the embodiment above, the computer system 102 may be a member of the peer group. This allows the computer system 102 to allow access to the device 112 to any peers in the peer group.

In some embodiments, the agent may be remote computer systems 483 connected to the computer system 102 via a network interface 453 and network connection 451. As described above, the network connection 451 may be any of the various network connections that exist at the present time or may exist in the future. Present connections include Bluetooth connections, wired and wireless connections and various other connections as described above. However, embodiments are not limited to the network connections recited herein, but may function with other, yet undiscovered connections.

As noted above, peer agents may be host systems, operating systems 435, frameworks, application code, and the like. When an agent is embodied as an operating system, a framework or application code, the agent may be included for example in the computer system 102.

Embodiments within the scope of this document also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions.

Those skilled in the art will appreciate that the teachings herein may be practiced in network computing environments with many types of computer system configurations, including personal computers, hand-held devices, multi-processor systems, microprocessor-based or programmable consumer electronics, network PCs, minicomputers, mainframe computers, and the like. The teachings herein may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computer network including one or more networked agents and one or more devices including one or more hardware peripherals and/or software services, a method of providing access to a device to networked agents, the method comprising acts of:
forming a peer-to-peer network of one or more members from among the networked agents, wherein the one or more members forms a peer group, the peer group not requiring a central authority defining peer group membership; and
providing access to a device to the one or more members forming the peer group based on their being included in the peer group.

2. The method of claim 1, wherein providing access to a device comprises a host coupled to the device being included in the peer group and providing access to the one or more members based on their being included in the peer group.

3. The method of claim 1, wherein providing access to a device comprises adding the one or more members forming the peer group to an access control list (ACL).

4. The method of claim 1, wherein providing access to a device comprises adding the peer group to an ACL.

5. The method of claim 1, wherein providing access to a device comprises registering the one or more members with a service on the peer-to-peer network, the service configured to add members added to the service to an ACL for providing access to the device.

6. The method of claim 5, wherein the service is a Web Service.

7. The method of claim 1, wherein providing access to a device comprises including the device in the peer group.

8. The method of claim 1, wherein at least one of the members is a host computer.

9. The method of claim 1, wherein at least one of the members is software including at least one of an operating system, a framework, and application code.

10. A computer-readable media including computer-executable instructions for performing the acts of claim 1.

11. In a computer network including one or more networked agents and one or more devices including one or more hardware peripherals and/or software services, a method of providing access to a device to networked agents, the method comprising acts of:
receiving a request for device access from one of the networked agents wherein the networked agent is a member of a peer group, the peer group not requiring a central authority defining peer group membership;
verifying that the networked agent is a member of the peer group; and
granting access to the networked agent based on membership in the peer group.

12. The method of claim 11, wherein receiving a request is performed at a service at the device.

13. The method of claim 12, wherein the service is a Web Service.

14. The method of claim 11, wherein verifying that the networked agent is a member of a peer group comprises performing a reverse look-up of an ACE for the peer group.

15. The method of claim 11, wherein verifying that the networked agent is a member of the peer group comprises verifying that the networked agent and the device are in the same peer group.

16. A computer-readable media including computer-executable instructions for performing the acts of claim 11.

17. A computer system for providing access to a device to agents in a peer-to-peer fashion such that the agents are organized into peer groups where the peer group does not require a central authority defining peer group membership, the computer system comprising:
a processor configured to run program modules; and
a storage medium configured to store data and program modules, the storage medium comprising:
a program module configured to verify membership in the peer group for one or more agents and to provide access to the device to agents based on peer group membership.

18. The computer system of claim 17, wherein the program module comprises a service configured to add members in the peer group to an ACL.

19. The computer system of claim 18, wherein the service is a Web Service.

20. The computer system of claim 17, wherein the program module is included as an agent in the peer group.

21. The computer system of claim 17, wherein the computer system comprises the device and wherein the computer system is included as a member of the peer group.

22. The computer system of claim 17, further comprising a network connection configured to connect to remote agents.

23. The computer systems of claim 17, wherein the computers system comprises an agent, the agent comprising at least one of an operating system, a framework, and application code.

24. The computer system of claim 23, wherein the service is a Web Service.
